(19) United States
(12) Patent Application Publication
(10) Pub. No.: US 2006/0074625 A1
(43) Pub. Date: Apr. 6, 2006

(54) Program development suport device, program execution device, compile method and debug method

(75) Inventor: Hironori Maeda, TOKYO (JP)

Correspondence Address: SUGHRUE MION, PLLC, 2100 PENNSYLVANIA AVENUE, N.W., SUITE 800, WASHINGTON, DC, 20037, US

(73) Assignee: ADVANTEST CORPORATION, TOKYO (JP)

(21) Appl. No.: 10/531,738

(22) PCT Filed: Oct. 17, 2003
(86) PCT No.: PCT/JP03/13302

§ 371 Date: Apr. 18, 2005

(30) Foreign Application Priority Data
Oct. 18, 2002 (JP) 2002-305010

(51) Int. Cl. G06F 17/20

(52) U.S. Cl. 704/8

(57) ABSTRACT

On a program development apparatus (workstation, for example), a description of a specific language source program (ATL, for example) is embedded into a preprocessor description of a general-purpose language source program (C language, for example) to create a mixed language source program. The general-purpose language source program description and the specific language source program description are extracted from the mixed language source program, compiled by respective compilers, and the respective object codes thus obtained are combined to form one object file.

### TECHNICAL FIELD

The present invention relates to a program development supporting apparatus for developing a specific language program that includes a description of a control command for a device under test such as a semiconductor device and a general-purpose language (GPL) program that includes a description on steps such as an execution step of the specific language program and a processing step of data obtained from the specific language program, a program executing apparatus for executing the programs, a compiling method of the programs and a debugging method of the programs. In particular, the present invention relates to a program development supporting apparatus, a program executing apparatus, a compiling method and a debugging method for developing a mixed language program where a specific language program and a general-purpose language program are mixed and described in one file.

### BACKGROUND ART

Many electronic devices such as measuring devices and communication devices, which are required to process a large volume of various types of signals, are provided with a high-performance processor. A program (firmware) to be performed on the processor tends to be complicated and large in size. The program recorded in the electric devices often includes unknown bugs. Further, customers often request addition or improvement of functions of the-devices.

In order to deal with these requirements, many electronic devices are made connectable with external computers via a communication cable which allows updating of the program and setting/monitoring of the operation. In other words, a control command or a control program itself can be distributed from an external computer to the processor of such an electronic device. Further, program algorithm and setting may be developed on the external computer to be operated on such an electronic device.

Among such electronic devices, a semiconductor test equipment is particularly unique since the semiconductor test equipment needs to operate on a wide variety of special-purpose semiconductor devices each of which needs to be tested with a specific device testing program. In recent years, it has become common that the user of the semiconductor test equipments, i.e., the semiconductor device manufacturer, develop a program executed on the processor of the semiconductor test equipment by himself.

However, most of the processors which are used in the special-purpose electronic devices, in particular, the semiconductor test equipments, tend to mount specific processors which can process only the binary files that comply with the specific specification. Then, a source file, which is used as a basis for such binary files, also has to be created according to a specific specification of the programming language and the development support environment, which, in turn, requires the program developers to be skilled not only in the programming language but also in the operation of specific development supporting environments.

In view of the above, some electronic devices are proposed which are capable of executing a program developed in the general-purpose language such as C language or JAVA (registered trademark). In such devices, however, program resources developed according to the specific specification cannot be utilized.

One conventional technique to eliminate such inconvenience is to describe entire data process and algorithm in general-purpose language such as C language and to call a program described in a language specific to each electronic device as a subroutine. An example of program development and execution according to this technique is described in detail below, where the electronic device that executes the program is assumed to be a semiconductor test equipment.

To facilitate the understanding of a program executing operation on the semiconductor test equipment, the semiconductor test equipment and the program development environment thereof are described. The semiconductor test equipment is a special measuring device that conducts a predetermined operation test on semiconductor devices such as a semiconductor memory device, a logic IC, a linear IC, and the device structure varies according to the types of semiconductor devices to be tested. Generally, a workstation is connected to the semiconductor test equipment to give a test execution direction to the semiconductor test equipment, to acquire test results, and to develop a program. The semiconductor test is realized with a semiconductor testing system consisting of a semiconductor test equipment and a workstation as disclosed in Japanese Patent Laid-Open No. 2001-195275 Publication.

FIG. 10 is a block diagram of an overall structure of a conventional semiconductor testing system, in which a structure common to different semiconductor test equipments for different device tests is shown. In FIG. 10, a semiconductor test equipment 100 includes a tester processor 110, a main tester unit 120, a tester head 130, and a communication interface 140.

The tester processor 110 serves to transmit a control command and to receive/transmit a test data to/from the main tester unit 120, and functions as a controller that controls the main tester unit 120 and communication with a workstation which will be described later. Specifically, the tester processor 110 includes an Operating System (OS) kernel 111 in an embedded memory (not shown) to perform a set-up and a monitoring of a device testing program, a memory management, as well as a monitoring/control of the communication interface 140, a control of the main tester unit 120, and the transmission of the test data, via a communication bus driver 112 and a tester bus driver 113 similarly stored in the memory.

The device testing program is configured with a general-purpose language program 114 and a specific language program 117 as described above, which as a whole define the procedure for executing various tests, such as a function test, and a DC parametric test, for a tested device 131. The general-purpose language program 114 is configured with a statement which includes a processing command for various data obtained as a result of test, and a statement which includes a command that indicates how to execute the entire device testing program, and is a binary file which is directly executable on the OS kernel 111.

On the other hand, the specific language program 117 is an object file which is configured with a command to control the main tester unit 120. The object file, similarly to the specific language program which is an inherited resource, is a binary file that is directly executable only on a kernel optimized for the specific language program 117. Hence, when the specific language program 117 is to be executed on the OS kernel 111, an execution emulator 115 has to perform an interpretation process. In addition, the specific language program 117 further includes an input/output command related with operations such as a disc access, keyboard input, monitor display, for a workstation 200 as described later. For the execution of such input/output command, in addition to the interpretation by the execution emulator 115, an interpretation by an IO control emulator 116 is required.

The main tester unit 120 serves to perform various tests, such as a function test, a DC parametric test, and an RF test (high harmonic test) on the tested device 131, which is mounted on the test head 130, according to the control command sent from the tester processor 110, and is provided with a register 121, a memory 122, and a test signal receiving/transmitting unit 123. The register 121 stores various data transmitted from the tester bus driver 113 in the tester processor 110. The stored data is in turn transmitted to the test signal receiving/transmitting unit 123 directly or via the memory 122.

Then, the test signal receiving/transmitting unit 123 outputs the data to be temporarily stored in the register 121 or the memory 122, and then to be transmitted to the tester bus driver 113 in the tester processor 110 via the register 121. The test signal receiving/transmitting unit 123 being configured with various test units such as a pattern generator, a timing generator, and a DC unit, outputs test signals generated by the test units and obtains data appear on an output pin of the tested device 131.

FIG. 11 is a block diagram of an overall structure of the workstation 200. The workstation 200 serves as a console terminal that transfers a program and gives an execution direction to the tester processor 110 in the semiconductor test equipment 100 as well as a program development supporting apparatus that supports the development of the general-purpose language program 114 and the specific language program 117. In FIG. 11, the workstation 200 includes a processor 220, a communication interface 241, a hard disc 242, a mouse 243, a keyboard 244, and a display 245.

The processor 220 includes an Operating System (OS) kernel 221 in an embedded memory (not shown), and performs processing such as set-up and monitoring of various programs, a memory management, monitoring and control of the communication interface 241, read-out/write-in of program and data from/to the hard disc drive 242, acquisition of information input from the mouse 243 and the keyboard 242, an output of display information to the display 245 via units that are similarly stored in the memory, such as a communication bus driver 223, a hard disc driver 224, a mouse driver 225, a keyboard driver 226, and a display driver 227. Here, the communication interface 241 is connected to the communication interface 140 shown in FIG. 10 via a communication cable (not shown) to allow the communication between the workstation 200 and the semiconductor test equipment 100.

Further, the OS kernel 221 includes a Graphical User Interface (GUI) processing unit 222. Various programs such as an editor 228, a general-purpose language compiler 229, a linker 233, a general-purpose language debugger 231, a specific language compiler 230, and a specific language debugger 232 can be executed on separate window screens displayed on the display 245. The workstation 200 is equivalent in configuration to a general computer. The various drivers and programs mentioned above are generally stored in the hard disc drive 242 to be read out and executed according to the OS kernel 221 as necessary.

Described next is the procedure of the development and the execution of the device testing program in the semiconductor testing system consisting of the semiconductor test equipment 100 and the workstation 200. FIG. 12 is a flowchart of a procedure of development and execution of a conventional device testing program. Here, the device testing program is configured with the general-purpose language program and the specific language program as described above. As an example, C language is adapted as the general-purpose language program and ATL (standard specific to Advantest Co.) is adapted as the specific language program.

First, the program developer starts up the editor 228 on the workstation 200 to create a source program in C language (at step S301). The source program describes an algorithm of the entire device testing program as described above, and defines procedure to call and execute the object program described in ATL and to process test result data obtained as a result of the execution.

After the creation of the source program in C language, the program developer designates a file of the created source program (hereinafter referred to as C source file including a necessary header file or the like) to a C compiler (corresponding to the general-purpose language compiler 229) to execute a compiling (at step S302). In the compiling process, a syntax checking is first performed. When a syntax error is found, the program developer corrects the error with the editor 228 and designates the execution of compile again. When no error is found, an object file, which is a translation of the C source file into a machine language (referred to as C object file hereinafter), is created.

After the completion of step S302, the program developer designates necessary library files for the created C, object files and makes the linker 233 execute the link for the C source files created at step S301 (at step 303). With the linking process, a single C object file is created which is directly executable on the tester processor 110 of the semiconductor test equipment 100.

Further, the program developer starts up the editor 228 on the workstation 200 to create a source program in ATL (at step S401) in parallel with the creation of the object files in C language. The source program, as described above, describes a control command for controlling the semiconductor test equipment 100.

After the completion of source program creation in ATL, the program developer designates a created source program file (referred to as ATL source file hereinafter) and makes an ATL compiler (corresponding to the specific language compiler 230) execute the compile (at step S402). Similarly to step S302 described above, in the compiling process, the syntax checking is first performed. When the syntax error is found the program developer corrects the error with the editor 228 and designates the execution of compile again. When no error is found, the ATL source program described above is translated into a machine language of an old tester processor which is different from the machine language used in the C object file, in other words, a machine language understandable to a specific tester processor, and an object file (referred to as ATL object file hereinafter) is created.

When the single C object file and the ATL object file group are prepared according to such procedure, the program developer starts up a control program to enable the communication with the semiconductor test equipment 100 on the workstation 200, and with the use of the started-up control program, transfers the single C object file and the ATL object file group to the tester processor 110 of the semiconductor test equipment 100 (at steps S304 and S403).

Then, the program developer designates the execution of the single C object file to the control program (at step S305). Then, according to the algorithm described in the single C object file, the tester processor 110 of the semiconductor test equipment 100 repeats the processing cycle starting from the execution of the ATL object file, the operation of a desired test unit in the main tester unit 120, acquisition of test result obtained from the tested device 131, up to data processing. Here, the test result to which appropriate data processing is conducted can be received according to the control program mentioned above via the communication interface 140 of the semiconductor test equipment 100, the communication cable, and the communication interface 241 of the semiconductor test equipment 100, and displayed on a window screen designated to the control program.

On finding inconvenience such as obvious error in test results, the program developer determines that the device testing program includes a logical error. Then the program developer starts up the general-purpose language debugger 231 on the workstation 200 to set a breakpoint in a predetermined statement in the C source file. When the program developer orders to start debugging, the general-purpose language debugger 231 executes the single C object file according to the procedure of steps S302 to S305 again. When it is detected that the process reaches the set breakpoint in the statement, a valid variable up to the breakpoint is displayed. The program developer, upon finding a logical error through the checking of the valid variable, starts up the editor 228 to correct the C source file as necessary and repeats the procedure of the steps S302 to S305 as described above.

On the other hand, when the general-purpose language debugger 231 does not find a logical error in the C source file, the program developer proceeds to start up the specific language debugger 232 to set a breakpoint in a predetermined statement in the ATL source file and to perform a debugging process as above.

As described earlier, however, when the program to be executed on the tested device (the semiconductor test equipment in the example here) is described in different languages such as the general-purpose language and the specific language, though the utilization of the past program resource written in the specific language is allowed, different source files are necessary in the development stage of the programs. In the above example, two different files need to be prepared as the C source file and the ATL source file. In brief, when the source file written in the general-purpose language includes a call of the object file written in the specific language, at least two source files are necessary. In particular, one general-purpose language source file needs to be managed in combination with corresponding specific language source file, since one general-purpose language source file corresponds with a specific language source file.

Further, identification of associated source files written in different languages based on the contents of the source files is difficult. Hence, mismanagement of the source files may cause wastes of time and energy for the relocating of source file association. Thus, the correction and partial citation of source files on the editor must be conducted with at most caution. Such inconvenience also contributes to increase the number of errors made by the program developer.

Still further, since both general-purpose language source file and the specific language source file are required to be prepared for one execution program, same number of object files are created as a result of compiling thereof. This means further complication in the management. Thus, conventionally source files and object files in different languages exist per one execution program, which complicates the file management and degrades the development efficiency of the program.

In view of the foregoing, an object of the present invention is to provide a program development supporting apparatus, a program executing apparatus, a compiling method and a debugging method which, through an embedding of a source file written in a specific language into a preprocessor description of a general-purpose language source file, allow a significant reduction in the number of necessary source files and object files per one execution file, and a utilization of past resource written in the specific language.

### DISCLOSURE OF INVENTION

To achieve an object as described above, a program development supporting apparatus according to the present invention is for generating a program file executable on a predetermined program executing apparatus from a mixed language source program where a specific language source program is described in a predetermined area of a general-purpose source program, and includes a specific language compiling unit (corresponding to a specific language compiler 30 described later) that compiles the specific language source program to create a specific language object code; a general-purpose language compiling unit (a general-purpose language compiler 29 as described later) that compiles the general-purpose language source program to create a general-purpose language object code; an integrated compiling unit (corresponding to an integrative compiler 34 as described later) that extracts the specific language source program from the mixed language source program, designates the extracted specific language source to the specific language compiling unit to execute, designate the mixed language source program to the general-purpose language compiling unit to execute, integrates the obtained specific language object code and the general-purpose language object code to create an object file; and a linking unit (corresponding to a linker 33 as described later) that create the program file from at least one object file created by the integrated compiling unit.

Further, a program executing apparatus (corresponding to a semiconductor test equipment 11 described later) according to the present invention executes a program file where an object code of a general-purpose language source program and an object code of a specific language source program are present in a mixed manner, and the object code of the general-purpose language source program and the object code of the specific language source program are loaded on a memory when an execution of the program file starts.

Still further, a compiling method according to the present invention is for generating a program file executable on a predetermined program executing apparatus from a mixed language source program where a specific language source program is described in a predetermined area of a general-purpose language source program, and includes a specific language source program extraction step (corresponding to step S121 described later) of extracting the specific language source program from the mixed language source program; a specific language compiling step (corresponding to step S123 described later) of compiling the extracted specific language source program to create a specific language object code; a general-purpose language compiling step (corresponding to step S122 described later) compiling a description of the general-purpose language source program from the mixed language source program to create a general-purpose language object code; an object file creation step(corresponding to step S124 described later) of combining the specific language object code and the general-purpose language object code to create an object file; and a linking step(corresponding to step S130 described later) of creating the program file from at least one object file created by the object file creation.

Still further, a debugging method according to the present invention is a debugging method for debugging a program file executable on a predetermined program executing apparatus created from a mixed language source program where a specific language source program is described in a predetermined area of a general-purpose language source program, and includes a breakpoint setting step of setting a breakpoint in a statement in the mixed language source program; a debugger starting up step of stopping the program file at the breakpoint during execution of the program file, starting up a general-purpose language debugger when the statement of the stopped program file belongs to the general-purpose language source program (corresponding to step S203 described later), and starting up a specific language debugger when the statement of the stopped program file belongs to the specific language source program (corresponding to step S206 described later); and a debug information display step of displaying on a common window screen debug information (corresponding to step S205 described later) obtained from the general-purpose language debugger and the specific language debugger (corresponding to steps S204 and S207 described later).

Further, a computer readable recording medium according to the present invention is characterized in that the compiling method is executed by a computer.

Further, a computer readable recording medium according to the present invention is characterized in that the debugging method is executed by a computer.

### BRIEF DESCRIPTION OF DRAWINGS

FIG. 1 is a block diagram of an overall structure of a semiconductor testing system according to an embodiment;

FIG. 2 is a flowchart of a procedure of development and execution of a device testing program;

FIG. 3 is an example of description by a C+ATL source program;

FIG. 4 is a flowchart of compiling process by an integrative compiler;

FIG. 5 is an explanatory diagram of a process of an ATL source file creation;

FIG. 6 is a diagram of a configuration of a C+ATL object file;

FIG. 7 is a flowchart of a debugger selecting routine;

FIG. 8 is an example of an execution screen of an integrative debugger when a break occurs in an ATL description;

FIG. 9 is an example of an execution screen of an integrative debugger when a break occurs in a C language description;

FIG. 10 is a block diagram of an overall structure of a conventional semiconductor testing system;

FIG. 11 is a block diagram of an overall structure of a workstation in a conventional semiconductor testing system; and

FIG. 12 is a flowchart of a procedure of development and execution of a conventional device testing program.

### BEST MODE(S) FOR CARRYING OUT THE INVENTION

In the following, an exemplary embodiment of a program development supporting apparatus, a program executing apparatus, a compiling method and a debugging method according to the present invention will be described in detail with reference to the accompanying drawings. The embodiment is not intended to limit the present invention.

To facilitate the understanding of features of the present invention, in an embodiment, the present invention is applied to a semiconductor testing system which is configured with a semiconductor test equipment and a workstation similarly to the conventional technique as described above. Specifically, the program development supporting apparatus according to the present invention corresponds to the workstation in the semiconductor testing system, the program executing apparatus according to the present invention corresponds to the semiconductor test equipment in the semiconductor testing system, and the compiling method and the debugging method according to the present invention correspond to the compiling method and the debugging method performed on the semiconductor testing system.

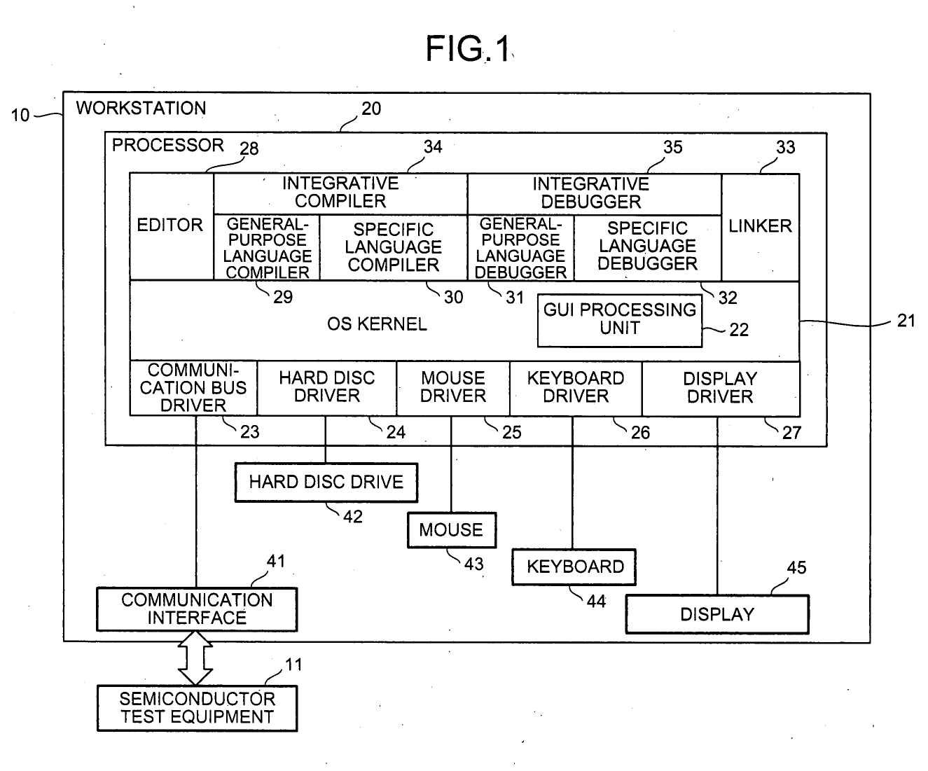

FIG. 1 is a block diagram of a semiconductor testing system according to the embodiment. The semiconductor testing system shown in FIG. 1 includes a workstation 10 and a semiconductor test equipment 11, connected via a communication cable with each other.

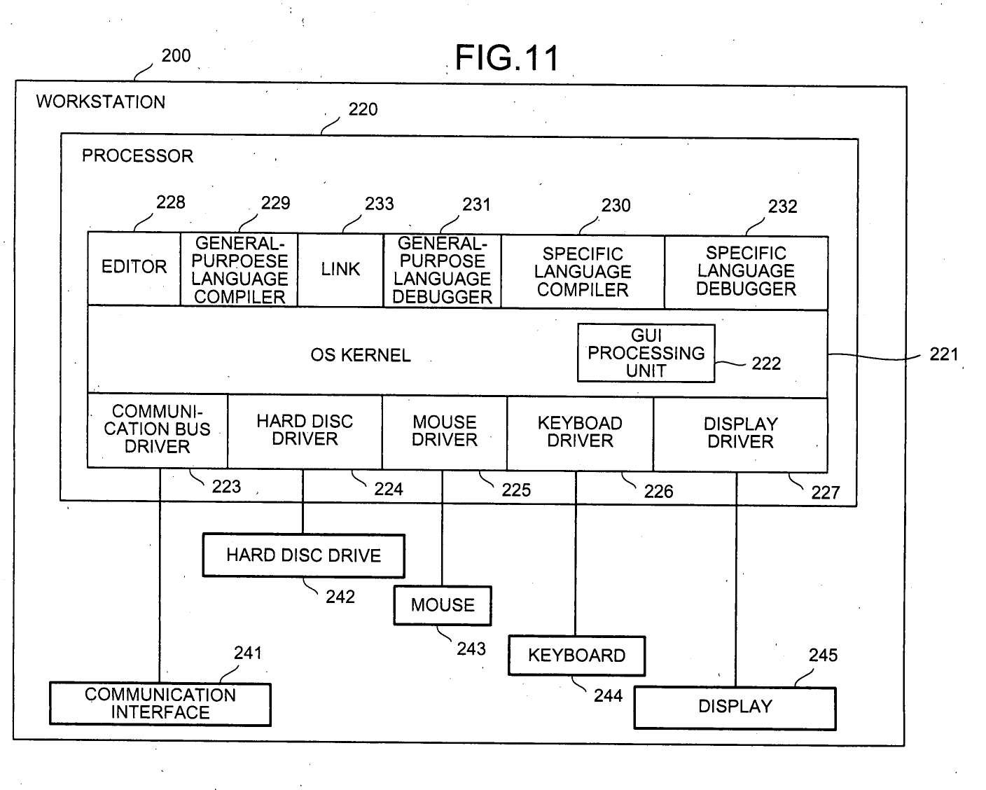

The basic structure of the workstation 10 is same with the structure of the workstation 200 of the conventional semiconductor testing system, and a processor 20, a communication interface 41, a hard disc drive 42, a mouse 43, a keyboard 44, and a display 45 shown in FIG. 1 correspond to the processor 20, the communication interface 41, the hard disc drive 42, the mouse 43, the keyboard 44, and the display 45 shown in FIG. 11, respectively.

Similarly, units stored in a memory (not shown) in the processor 20 such as an OS kernel 21, a GUI processing unit 22, a communication bus driver 23, a hard disc driver 24, a mouse driver 25, a keyboard driver 26, a display driver 27, an editor 28, a general-purpose language compiler 29, a specific language compiler 30, a general-purpose language debugger 31, a specific language debugger 32, and a linker 33 correspond to the OS kernel 221, the GUI processing unit 222, the communication bus driver 223, the hard disc driver 224, the mouse driver 225, the keyboard driver 226, the display driver 227, the editor 228, the general-purpose language compiler 229, the specific language compiler 230, the general-purpose language debugger 231, the specific language debugger 232, and the linker 233 shown in FIG. 11, respectively.

The workstation 10 according to the embodiment differs from the conventional workstation 200 in that the workstation 10 includes an integrative compiler 34 as an upper level application of the general-purpose language compiler 29 and the specific language compiler 30. In other words, the workstation 10 can utilize the general-purpose language compiler 29 and the specific language compiler 30 via the integrative compiler 34.

Further, the workstation 10 according to the embodiment differs from the conventional workstation 200 in that the workstation 10 includes an integrative debugger 35 as an upper level application of the general-purpose language debugger 31 and the specific language debugger 32. The workstation 10 can utilize the general-purpose language debugger 31 and the specific language debugger 32 via the integrative debugger 35 in a similar manner with the integrative compiler 34.

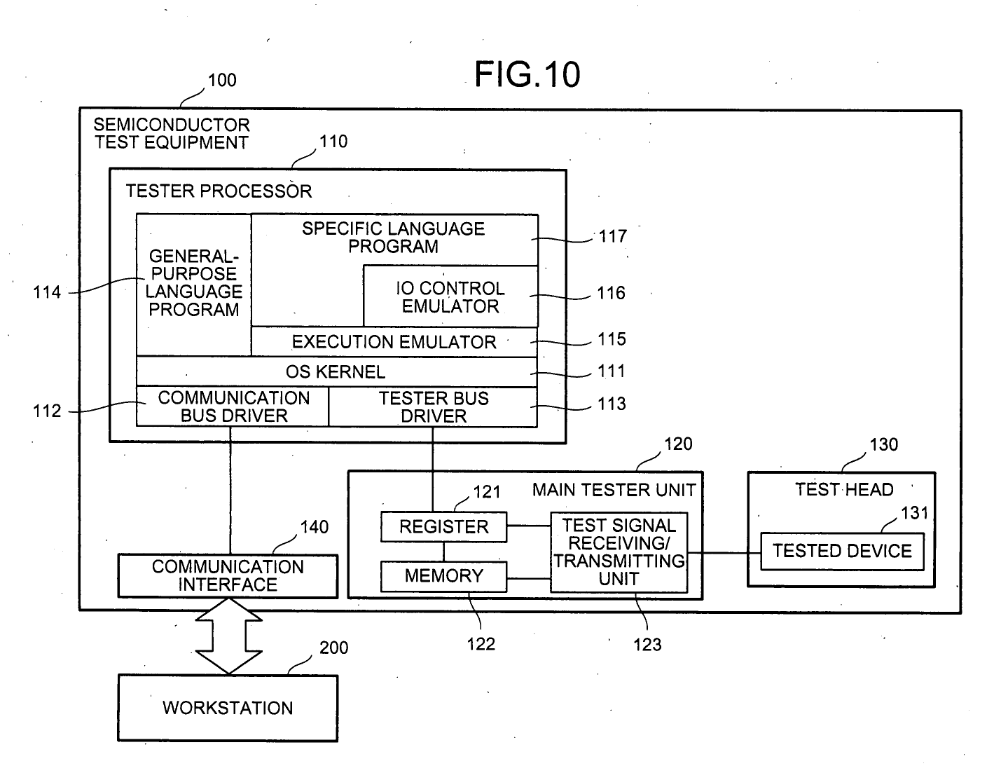

The semiconductor test equipment 11 is shown to be connected to the workstation 10 in the semiconductor testing system of FIG. 1, and the internal structure of the semiconductor test equipment 11 is same with the conventional semiconductor test equipment 100 shown in FIG. 10. In the semiconductor test equipment 11, however, the tester processor operates partially differently from the conventional processor depending on a type of a program to be developed in the workstation 10.

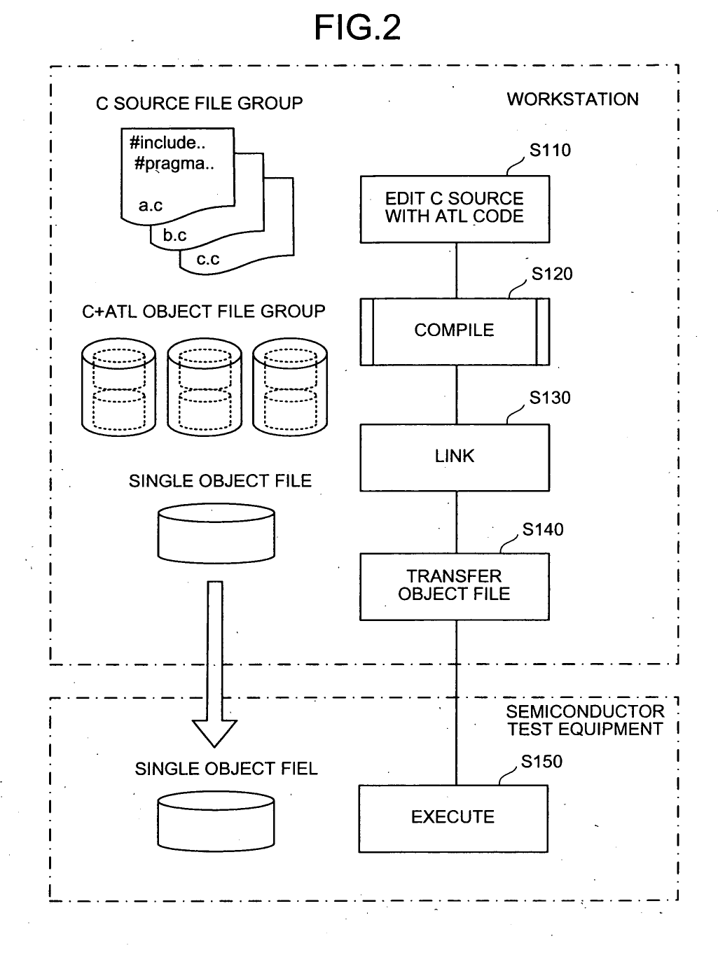

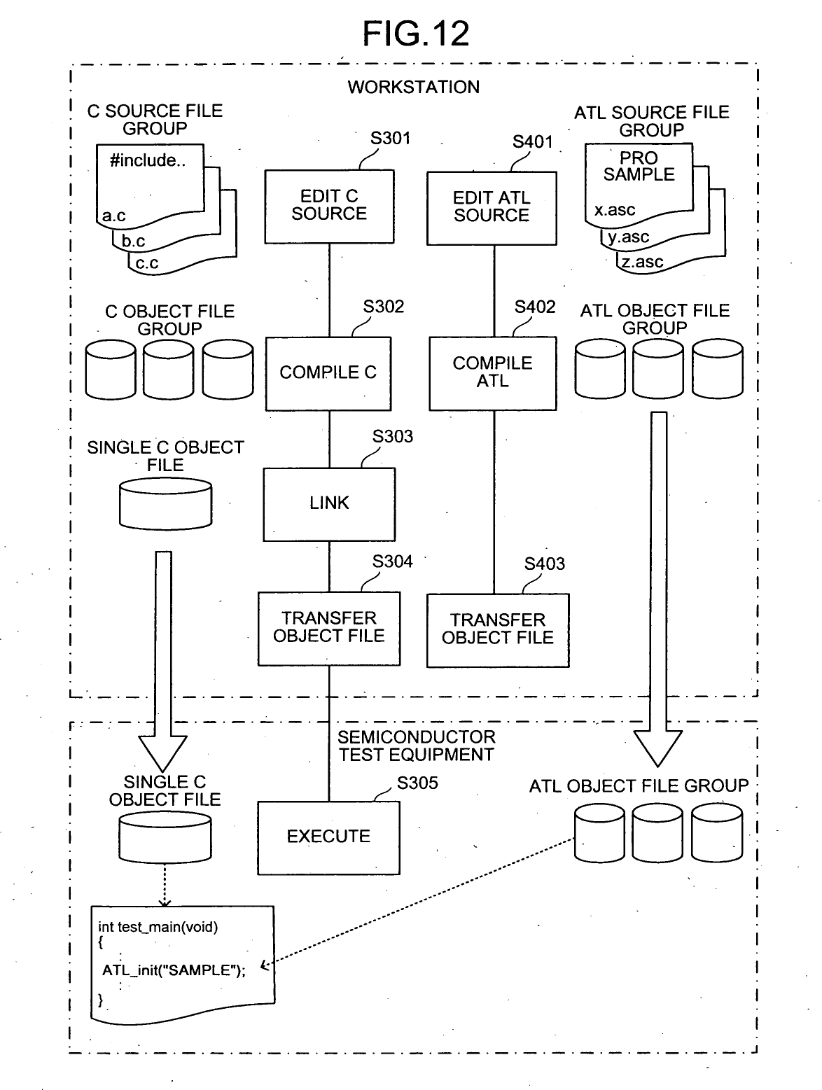

A procedure of development and execution of a device testing program in the semiconductor testing system is described. FIG. 2 is a flowchart of a procedure of the development and the execution of the device testing program according to the embodiment. Similarly to the description of FIG. 12, in an example shown in FIG. 2, the device testing program is configured with the general-purpose language program and the specific language program, and C language is adapted as the general-purpose language program and ATL (standard specific to Advantest Co.) is adapted as the specific language program.

First, the program developer starts up the editor 28 on the workstation 10 to create a source program (at step S110). The source program written in the C language which is the general-purpose language includes in a preprocessor description the content of ATL source file written in the specific language, unlike the content of C source file of FIG. 12. Such source program is referred to as a C+ATL source program.

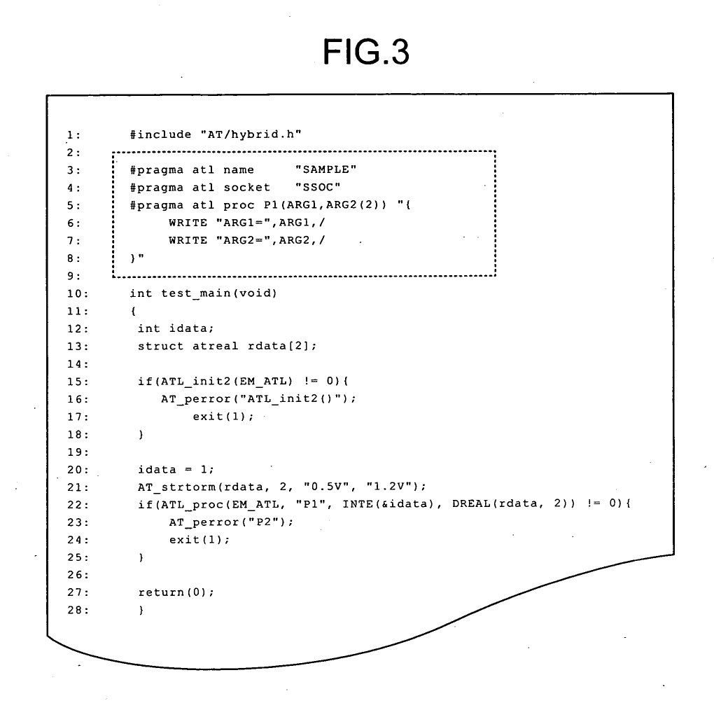

FIG. 3 shows an example of the C+ATL source program description. A description of “number:” at the left end of the description in FIG. 3 is a row number used for descriptive purpose and ignored in the actual program operation. In the following description of the content of the C+ATL source program, each statement will be referred to with the row number.

The C language compiler recognizes a statement starting from # as a preprocessor command. In the C+ATL source program shown in FIG. 3, “#include” with row number 1, “#pragma” with row numbers 3, 4, and 5 are the preprocessor commands. The command “#include” is a command to simply expand the content of description of a header file “AT/hybrid.h” at the position, and the content of the command is necessary for a main function starting from the row number 10.

On the other hand, “#pragma” is a special preprocessor command to realize a unique function of the machine or the OS while maintaining the overall compatibility with the C language. Hence, by definition, “#pragma” is unique to the machine or the OS and generally different for each compiler. The command “#pragma” is basically used for granting a new function to the preprocessor or for providing information dependent on implement to the compiler. In the C+ATL source program created according to the embodiment, a description in ATL, which is a specific language, is embedded as a token given by “#pragma”. Processing of the ATL description given by “#pragma” will be described later.

The contents of the description, which define processes such as the call of the ATL object file, and data process, in the row numbers 10 to 28 in the C+ATL source program shown in FIG. 3 are same with the contents created on the workstation of the conventional semiconductor testing system.

After the completion of the creation of the C+ATL source program, the program developer designates a file of the created C+ATL source program (hereinafter referred to as a C+ATL source file including necessary files such as a header file) to the integrative compiler 34 to execute the compile (at step S120). At the execution of the compile, the syntax checking is first performed and when the syntax error is found, the program developer corrects the error with the editor 28 and designates the execution of compile again. When no error is found, the compiling process for creating the object file starts.

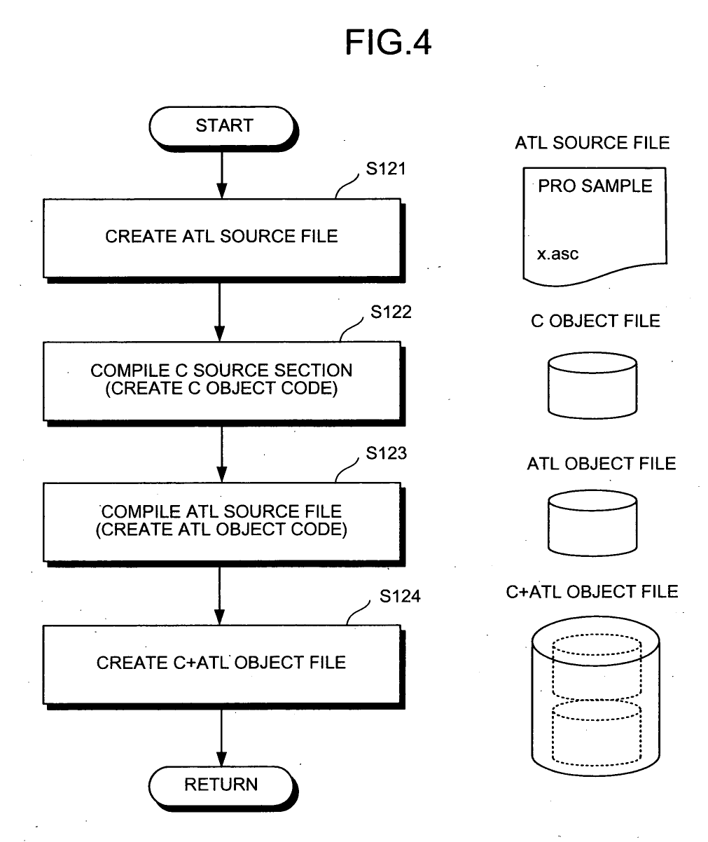

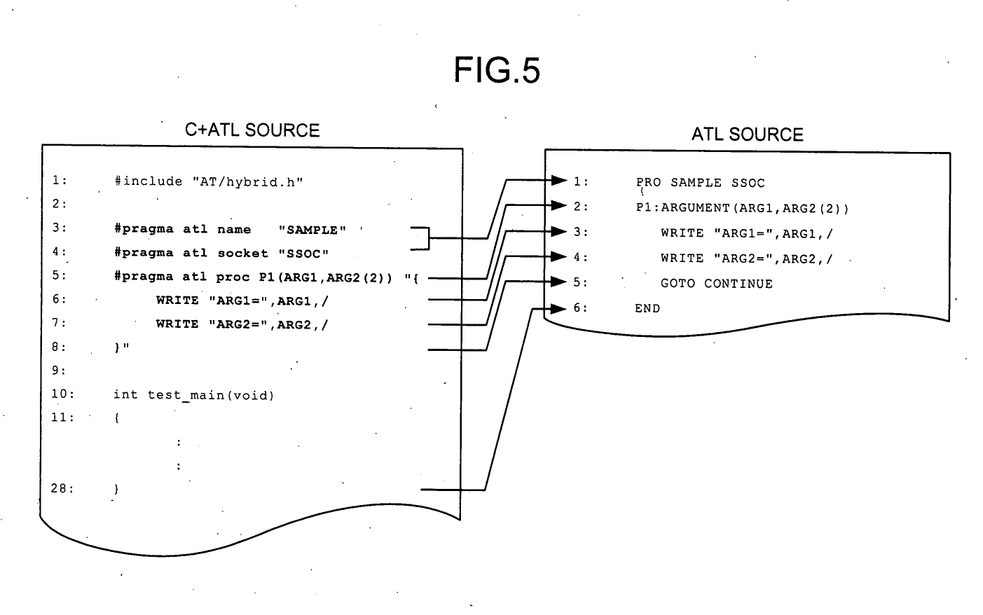

FIG. 4 is a flowchart of the compiling process conducted by the integrative compiler 34. When no syntax error is-found in the C+ATL source file created at the step S110, the integrative compiler 34 proceeds to extract the ATL description from the C+ATL source file to create the ATL source file (at step S121). FIG. 5 is shown to describe the process of ATL source file creation. The creation process of the ATL source file, as described above, starts with the identification of “#pragma” from the preprocessor description in the C+ATL source file and the analysis of a token following the “#pragma”. In an example shown in FIG. 5, “atl” immediately after “#pragma” is a keyword which indicates that the following information is the ATL description.

More specifically, with reference to the example of FIG. 5, the integrative compiler 34, upon recognizing “#pragma atl” in the row number 3, extract the following keyword “name”, thereby interpreting that the description marked with a double quotation mark following the keyword “name”, i.e., “SAMPLE”, is a program name. According to the interpretation, “PRO SAMPLE” is inserted at the beginning of the ATL source file. Then, the integrative compiler 34, recognizing “#pragma atl” in the row number 4, extracts the following keyword “socket” and interprets that the description marked with a double quotation mark following the keyword “socket”, i.e., “SSOC” is a socket program name of the ATL. According to the interpretation, “SSOC” is inserted after “PRO SAMPLE” in the ATL source file. Then, the integrative compiler 34, recognizing “#pragma atl” in the row number 5, extracts the following keyword “proc” and interprets that the character sequence immediately after the keyword “proc” and the following description marked with a double quotation mark, i.e., “P1 (ARG1, ARG2(2)) “{WRITE “ARG1=”, ARG1,/WRITE “ARG2=”, ARG2,/}”, as a function definition. According to the interpretation, the description
P1:ARGUMENT (ARG1, ARG2(2))
   WRITE “ARG1=”, ARG1,/
   WRITE “ARG2=”, ARG2,/
   GOTO CONTINUE
      is added to the ATL source file.

Then, the integrative compiler 34, upon reaching the last row number (row number 28) of the C+ATL source file without finding any more “#pragma atl” in the C+ATL source file, inserts “END” in the tail of the ATL source file to finish the creation of the ATL source file.

After the completion of the ATL source file creation, the integrative compiler 34 conducts a compiling of C language description in the C+ATL source file, i.e., a creation of C object code (at step S122). The ordinary C compiler (corresponding to the general-purpose language compiler 29) conducts the compile, ignoring the description of “#pragma” described above. In the embodiment the integrative compiler 34 calls the C compiler for the process, however, the function of the C compiler may be embedded into the integrative compiler 34 itself to perform the C object code creation in parallel with the ATL source file creation described above. Then, the general-purpose language compiler 29 shown in FIG. 1 may be unnecessary.

After the completion of the C object code creation, the integrative compiler 34 conducts a compile of the ATL source file created at step S121, i.e., the creation of the ATL object code (at step S123). With the call of the ATL compiler (corresponding to the specific language compiler 30), the compile is executed. Similar to step S402 of FIG. 12, the file is translated into a machine language specific to the old tester processor (machine language comprehensible in a specific tester processor) which is different from a machine language described in the C object code.

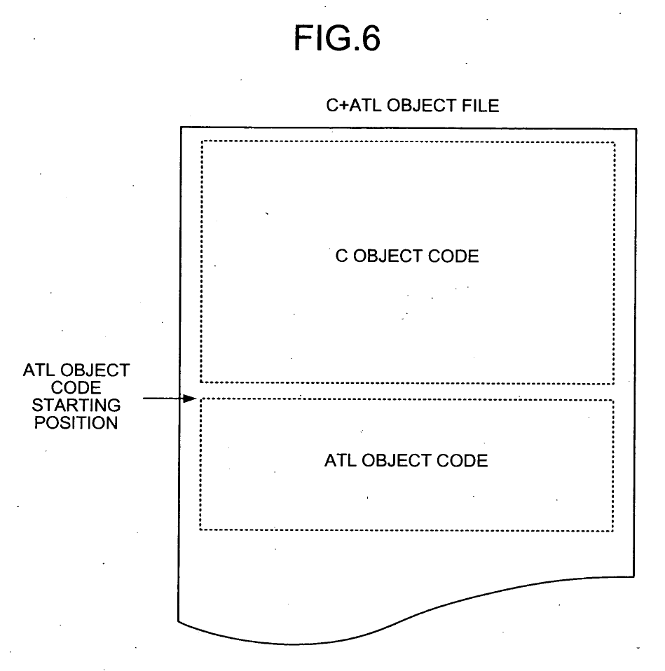

After the completion of the creation of the ATL object code, the integrative compiler 34 combines the C object code created at step S122 with the ATL object code created at step S121 and adds position information of a location where the ATL object code is stored (ATL object code starting point), to create an object file (hereinafter referred to as “C+ATL object file”) (at step S124). FIG. 6 shows a structure of such C+ATL object file. As shown in FIG. 6, in the C+ATL object file, the ATL object code is arranged after the C object code. In FIG. 6, additional information such as the position information of the ATL object code is now shown.

The integrative compiler 34 conducts the compiling process on the C+ATL source files created in the same manner, thereby preparing a plurality of C+ATL object files. After the compiling process by the integrative compiler 34, the program developer designates to the linker 33 necessary library files for the plurality of C+ATL object files created as described above and the like, to execute linking (step S130 of FIG. 2).

The linker 33, in addition to the necessary library files for the plurality of C+ATL object files created as described above and the like, prepares and links a load program for loading the ATL object code section from each of the C+ATL object files to create a single object file directly executable on the tester processor of the semiconductor test equipment 11.

When the single object file is ready after the procedure as described above, the program developer starts up a control program that enables the communication with the semiconductor test equipment 11 on the workstation 10 to transfer the single object file to the tester processor of the semiconductor test equipment 11 using the control program (at step S140).

Then, the program developer gives an execution direction of the single object file to the control program (at step S150). In response to the direction, the tester processor of the semiconductor test equipment 11 first loads the C object cod and the ATL object code arranged in the single object file on the memory according to the load program included in the single object file. The tester processor then repeats the process of: an execution of the loaded ATL object code; an operation of a desired testing unit in the main tester unit; an acquisition of test results from the tested device; and data processing, according to the algorithm described in the loaded C object code. Here, the test result, after appropriate data processing, may be received by the control program mentioned above via the communication interface of the semiconductor test equipment 11, the communication cable, and the communication interface 41 of the workstation 10, and displayed on a window screen allocated to the control program similarly to the conventional technique.

Though the load program is assumed to be included in the single object file here, the load program may be previously read out and stored in the tester processor of the semiconductor test equipment 11 and started up at the beginning of the process according to the execution direction from the workstation 10.

Next, the debugging process of the semiconductor testing system according to the embodiment will be described. The program developer, when inconveniences such as the abnormality are found from the test result obtained through the execution of step S150, performs the debugging process on the device test program as in the conventional technique. First, the program developer starts up the integrative debugger 35 on the workstation 10 to set a breakpoint in a predetermined statement in the C+ATL source file.

Then, in response to the direction to start debugging sent from the program developer, the integrative debugger 35 executes the single object file according to the procedure of steps S120 to S150 described above. Upon detection that the processing reaches the breakpoint in the executed statement, the integrative debugger 35 executes a debugger selecting routine to select which of a C debugger (corresponding to the general-purpose language debugger 31) or an ATL debugger (corresponding to the specific language debugger 32) is to be started up.

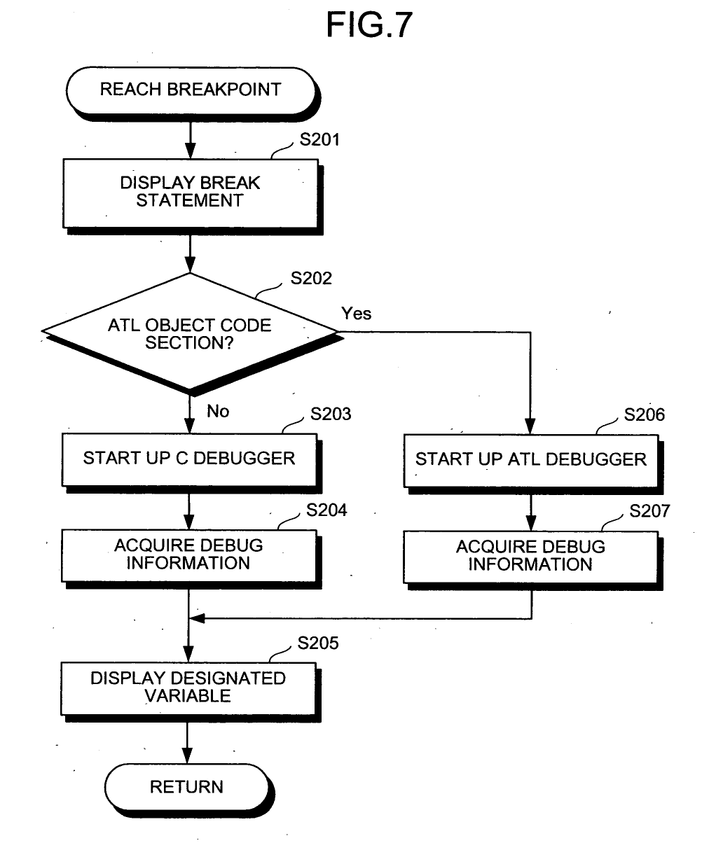

FIG. 7 is a flowchart of the debugger selecting routine. The integrative debugger 35, when the process reaches the breakpoint of the statement sequentially executed in the single object file, displays the statement in which the breakpoint is set (at step S201). Then, when the statement is in the ATL object code section (Yes in step S202), the integrative debugger 35 starts up the ATL debugger (at step S206) to-acquire debug information such as a variables included in the statement with breakpoint from the ATL debugger (at step S207). Here, when the breakpoint is set as mentioned above, the ATL debugger acquires breakpoint setting information of the ATL object code section via the integrative debugger.

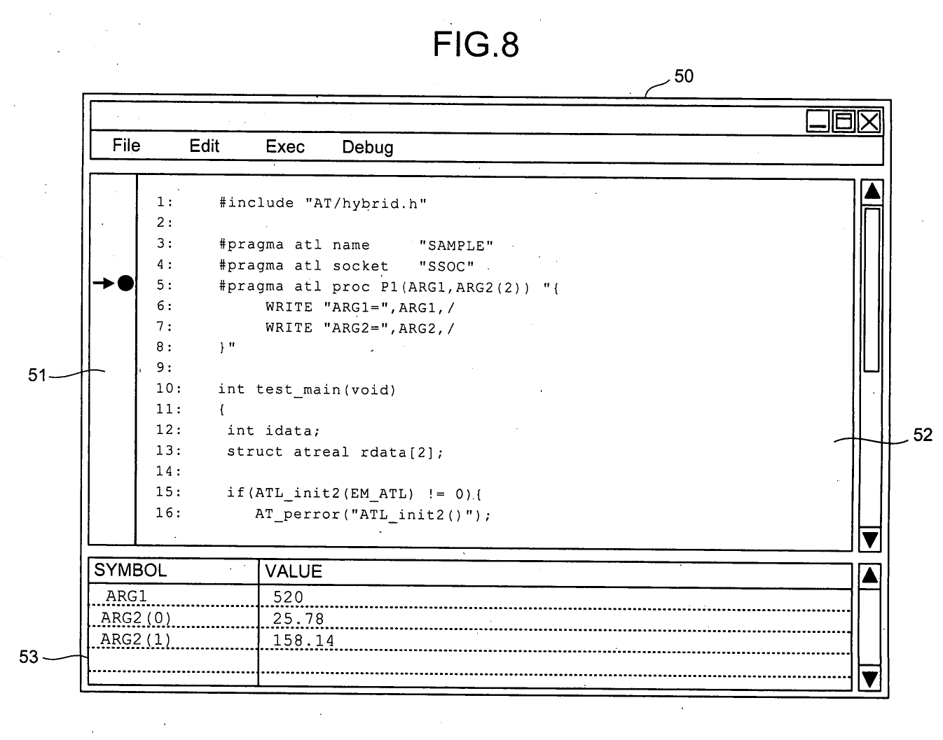

The integrative debugger 35, upon acquiring the debug information from the ATL debugger, displays a designated variable (symbol) which is rendered effective at the time of break (at step S205). FIG. 8 shows an example of an execution screen of the integrative debugger 35, particularly in a condition where the break is occurred in the ATL description. In FIG. 8, the integrative debugger 35, in addition to a standard window display setting as title bar and a menu bar in an execution window 50, displays a breakpoint setting area 51, a source display area 52, and a symbol display area 53. In FIG. 8, to indicate the break state of the ATL description in the C+ATL source program, the statement with the row number 5 where the breakpoint is set is shown in the source display area 52, and variables and values the variables in the statement can take are shown in the symbol display area 53.

On the other hand, the integrative debugger 35, when the statement with a break is in the C object code section (No at Step S202), starts up the C debugger (at step S203) to acquire debug information such as a variable included in the statement with break from the C debugger (at step S204). Here, the C debugger, at the time of breakpoint setting, acquires the breakpoint setting information of the C object code section via the integrative debugger 35.

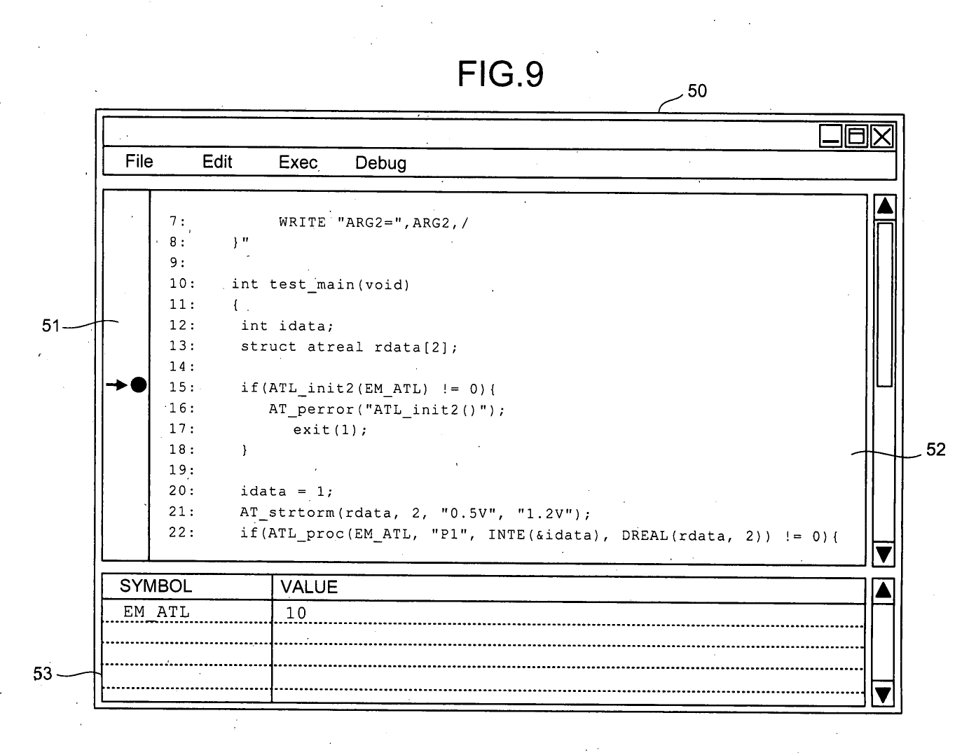

The integrative debugger 35, upon acquiring the debug information from the C debugger, displays a designated variable (symbol) which is rendered effective at the break (at step S205). FIG. 9 shows an example of an execution screen of the integrative debugger 35, particularly in a state where the break is occurred in the C language description. The execution window 50 of the integrative debugger 35 shown in FIG. 9 is of similar configuration with the window shown in FIG. 8. In FIG. 9, to indicate the state where the break is occurred in the C language description of the C+ATL source program, the statement with the row number 15 with the breakpoint is shown in the source display area 52 and a variable and a value the variable in the statement can take are displayed in the symbol display area 53.

The program developer, upon finding a logical error through checking of the variable displayed on the window screen of the integrative debugger 35, starts up the editor 28 to correct the C+ATL source file as necessary and to repeat the procedure of steps S120 to S150.

As described above, the semiconductor testing system according to the embodiment, i.e., the program development supporting apparatus, the program executing apparatus, the compiling method and the debugging method according to the present invention, through the embedding of the ATL source which is the specific language program into the C language source which is the general-purpose language program, allows the handling of two different sources, which are conventionally managed separately, as one C+ATL source file, whereby the file management is simplified and the efficiency of program development is enhanced.

In the embodiment, the workstation and the semiconductor test equipment are employed as examples of the program development supporting apparatus and the program executing apparatus according to the present invention. It is clear, however, that general-purpose computer system and devices such as measuring device or a control device communicative with the computer system can be employed as the program development supporting apparatus and the program executing apparatus.

As described above, the program development supporting apparatus, the program executing apparatus, the compiling method and the debugging method according to the present invention, through the embedding of the specific language program itself into the general-purpose language program, allows the handling of the different source programs which are conventionally managed separately as one file not only at the stage of the source file but also at the stage of the object file created through compiling, whereby the file management is simplified and the efficiency of program development is improved.

### INDUSTRIAL APPLICABILITY

As can be seen from the foregoing, the program development supporting apparatus, the program executing apparatus, the compiling method and the debugging method according to the present invention is useful for efficient development of the high-performance program (firmware) for electronic devices and simplification of program management, and in particular is suitable for the development and the management of programs for semiconductor test equipments.

1. A program development supporting apparatus for generating a program file executable on a predetermined program executing apparatus from a mixed language source program where a specific language source program is described in a predetermined area of a general-purpose source program, comprising:
a specific language compiling unit that compiles the specific language source program to create a specific language object code;
a general-purpose language compiling unit that compiles the general-purpose language source program of the mixed language source program to create a general-purpose language object code;
an integrated compiling unit that extracts the specific language source program from the mixed language source program, makes the specific language compiling unit execute by designating the extracted specific language source, makes the general-purpose language compiling unit execute by designating the mixed language source program, and integrates the obtained specific language object code and the general-purpose language object code to create an object file; and
a linking unit that creates the program file from at least one object file created by the integrated compiling unit.

2. The program development supporting apparatus according to claim 1, wherein the integrated compiling unit adds code position information of at least one of the specific language object code and the general-purpose language object code.

3. The program development supporting apparatus according to claim 1, further comprising a program transferring unit that transfers the program file to the program executing apparatus.

4. The program development supporting apparatus according to claim 3, further comprising a program executing apparatus controlling unit that gives an instruction to the program executing apparatus to execute the program file transferred to the program executing apparatus.

5. The program development supporting apparatus according to claim 1, further comprising a breakpoint setting unit that sets a breakpoint in a statement in the mixed language source program, wherein
the execution of the program file is stopped at the breakpoint during the execution, a general-purpose language debugger is started up when the statement of the stopped program file belongs to the general-purpose language source program, and a specific language debugger is started up when the statement of the stopped program file belongs to the specific language source program.

6. The program development supporting apparatus according to claim 5, wherein debug information obtained from the general-purpose language debugger and the specific language debugger are displayed on a common window screen.

7. The program development supporting device according to claim 1, wherein the general-purpose language is C language and the specific language source program is described in the general-purpose language source program by a preprocessor command in the general-purpose language source program.

8. The program development supporting apparatus according to claim 7, wherein the preprocessor command is “#pragma”.

9. The program development supporting apparatus according to claim 1, wherein the program executing apparatus is a semiconductor test equipment.

10. A program executing apparatus that executes a program file where an object code of a general-purpose language source program and an object code of a specific language source program are present in a mixed manner, wherein
the object code of the general-purpose language source program and the object code of the specific language source program are loaded on a memory when an execution of the program file starts.

11. The program executing apparatus according to claim 10, wherein the program executing apparatus is a semiconductor test equipment.

12. A compiling method for generating a program file executable on a predetermined program executing apparatus from a mixed language source program where a specific language source program is described in a predetermined area of a general-purpose language source program, comprising:
a specific language source program extraction step of extracting the specific language source program from the mixed language source program;
a specific language compiling step of compiling the extracted specific language source program to create a specific language object code;
a general-purpose language compiling step of compiling a description of the general-purpose language source program of the mixed language source program to create a general-purpose language object code;
an object file creation step of combining the specific language object code and the general-purpose language object code to create an object file; and
a linking step of creating the program file from at least one object file created by the object file creation.

13. A debugging method for debugging a program file executable on a predetermined program executing apparatus created from a mixed language source program where a specific language source program is described in a predetermined area of a general-purpose language source program, comprising:
a breakpoint setting step of setting a breakpoint in a statement in the mixed language source program;
a debugger starting up step of stopping the program file at the breakpoint during execution of the program file, starting up a general-purpose language debugger when the statement of the stopped program file belongs to the general-purpose language source program, and starting up a specific language debugger when the statement of the stopped program file belongs to the specific language source program; and
a debug information display step of displaying-debug information obtained from the general-purpose language debugger and the specific language debugger on a common window screen.

14. A computer readable recording medium that records a program that makes a computer execute steps to create a program file executable on a predetermined program executing apparatus from a mixed language source program where a specific source program is described in a predetermined area of a general-purpose language source program, the steps comprising:
a specific source program extraction step of extracting the specific language source program from the mixed language source program;
a specific language compiling step of compiling the extracted specific language source program to create a specific language object code;
a general-purpose language compiling step of compiling a description of the general-purpose language source program from the mixed language source program to create a general-language object code;
an object file creation step of combining the specific language object code and the general-purpose language object code to create an object file; and
a linking step of creating the program file from at least one object file created by the object file creation.

15. A computer readable recording medium that records a program that makes a compute execute steps to debug a program file executable on a predetermined program executing apparatus created from a mixed language source program where a specific language source program is described in a predetermined area of a general-purpose language source program, the steps comprising:
a breakpoint setting step of setting a breakpoint in a statement in the mixed language source program;
a debugger starting up step of stopping the program file at the breakpoint during execution of the program file, starting up a general-purpose language debugger when the statement of the stopped program file belongs to the general-purpose language source program, and starting up a specific language debugger when the statement of the stopped program file belongs to the specific language source program; and
a debug information display step of displaying debug information obtained-from the general-purpose language debugger and the specific language debugger on a common window screen.
